(19) United States
(12) Patent Application Publication
(10) Pub. No.: US 2016/0156816 A1
(43) Pub. Date: Jun. 2, 2016

(54) ADAPTER AND CASING APPARATUS FOR AN IMAGING DEVICE

(71) Applicant: PANO PRO LTD, Bideford (GB)

(72) Inventor: Barnaby Douglas Grant Brown, Buckland Brewer (GB)

(21) Appl. No.: 14/904,660

(22) PCT Filed: Jul. 11, 2014
(86) PCT No.: PCT/GB2014/052123

§ 371 Date: Jan. 12, 2016

(30) Foreign Application Priority Data
Jul. 12, 2013 (GB) 1312542.2

(51) Int. Cl. H04N 5/225; G02B 7/02; G02B 27/00; G02B 7/14; G02B 13/06; G02B 1/11

(52) U.S. Cl. CPC H04N 5/2252; G02B 13/06; G02B 1/11; G02B 27/0025; G02B 7/14; G02B 7/023; H04N 5/2253; H04N 5/2254

(57) ABSTRACT

An adapter and casing apparatus (10) for an imaging device (26) such as portable sports cameras. The apparatus includes a mirror (22) which reflects a 360 degree image surrounding the apparatus (10) toward an existing lens (20) of the imaging device (26) such that a panoramic view can be recorded by the imaging device (26). A casing (12) encapsulates the imaging device (26) and has an attachment means which allows a locating member ((16) to be attached and which retains the mirror (22) at a desired distance from a lens of the imaging device ((26). This secures the mirror (22) relative to the imaging device (26) in order to focus the image reflected from the mirror (22) into the imaging device (26) without any modification to the imaging device (26) being required.

The present invention relates to adapter and casing apparatus for an imaging device, particularly, but not exclusively, adapter and casing apparatus for attachment to a small portable camera such as those that are typically attached to equipment or users during sporting pursuits in order to capture still or moving images thereof.

Small portable cameras have become increasingly popular in recent years partly due to significant reductions in the cost, size and weight of electrical components. Improvements in the casing and body of cameras have also resulted in increased use of such cameras in relatively extreme environments. This has led to an increased desire to capture moving and still images of events, and participation in sporting events, in different and interesting ways.

It is known to provide camera's with adapters having convex reflectors in order to obtain a 360 degree view of a camera's surroundings. However, such existing adapters are often cumbersome, expensive and require modifications to be made to the lens, aperture or other components of the existing camera prior to use.

According to a first aspect of the present invention there is provided adapter and casing apparatus for an imaging device, the apparatus comprising a mirror arrangement adapted to reflect an image of a view surrounding at least a portion of the apparatus toward an existing lens of the imaging device, a casing member for encapsulating the imaging device, locating member attachment means provided on the casing member, a locating member adapted to retain the mirror arrangement at a desired distance from said existing lens of the imaging device, casing attachment means provided on the locating member for engagement with the locating member attachment means of the casing member such that the mirror may be secured relative to the existing lens of the imaging device to thereby focus said image reflected from the mirror arrangement into said existing lens of said imaging device in order to obtain a focussed image of said view surrounding the apparatus.

Such an arrangement has the advantage of collecting a 360 degree image of a camera's surroundings whilst not requiring any modification to the existing camera.

Further features and advantages of the present invention will be made apparent from the following description and attached claims.

Embodiments of the present invention will now be described by way of example only, with reference to the following diagrams, in which:

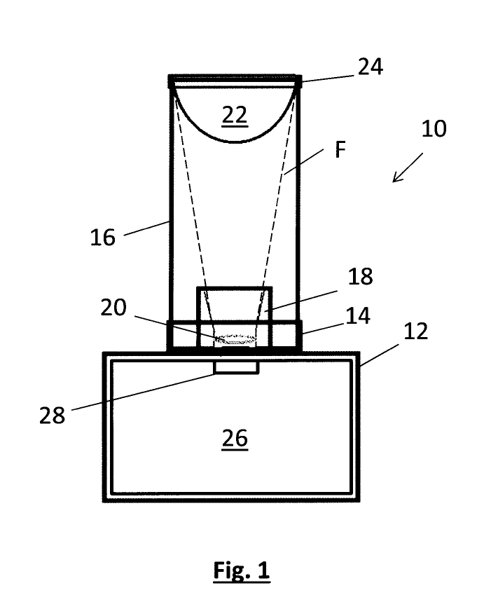

FIG. 1 is a schematic transverse illustration of an adapter according to a first aspect of the present invention, where the adapter is attached to the front of an existing imaging device;

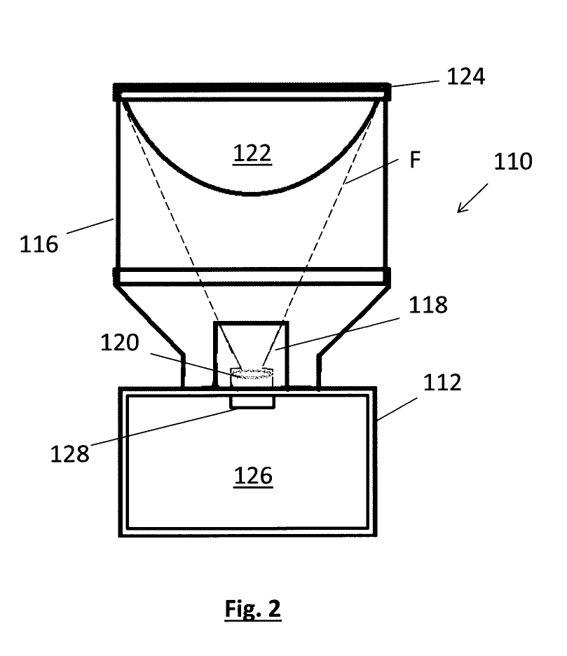

FIG. 2 is a schematic transverse illustration of a larger diameter adapter according to a second aspect of the present invention; and

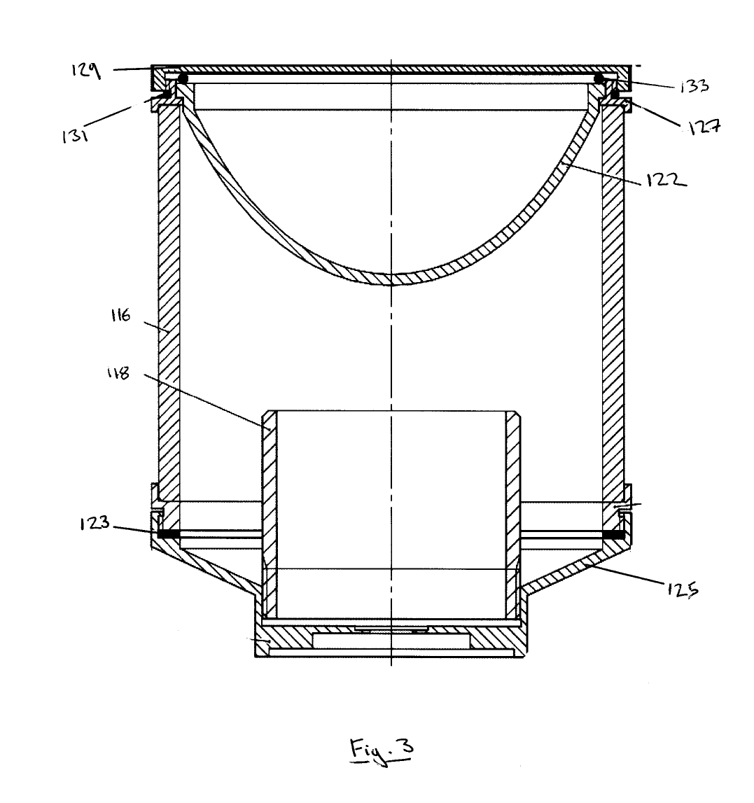

FIG. 3 is a schematic cross sectional view of the apparatus shown in FIG. 2 in greater detail.

With reference to FIG. 1, in a first embodiment of the present invention, an adapter apparatus 10 comprises a main housing or casing 12, locating member attachment means in the form of a threaded collar 14 provided on the front of the casing 12, a transparent tubular locating member 16 attached to the threaded collar 14, a field of view restrictor 18 containing a corrective lens 20 and a 360 degree convex mirror 22 mounted at the upper end of the tubular locating member 16. A cap 24 is also provided over the base of the convex mirror 22/end of the tubular locating member 14. The locating member 16 is also provided with casing attachment means in the form of a threaded formation corresponding to the threaded collar 14 in order to allow screwed engagement between the locating member 16 and the casing 12.

The main casing 12 contains and protects an imaging device such as a camera 26 having an existing aperture and lens arrangement generally referenced 28.

The main casing 12 surrounding the camera 26 comprises a rugged plastic material such as transparent or opaque ABS plastic or a similar material. In the present embodiment, the casing 12 is provided in two or more parts which allow the casing 12 to encapsulate the camera 26 therein. A resilient rubber washer is provided around the edges of the two parts of the casing 12 in order to create a substantially water-tight seal therebetween. Although not illustrated in FIG. 1, clips and/or strapping may be provided to ensure that, when the two parts of the casing 12 are clicked together, a secure seal is formed around the camera 26. Small pads of protective material, such as foam may also be provided at appropriate locations within the casing 12 in order to hold the camera 26 securely therein.

The threaded collar 14 is integrated into the front of the casing 12 in order to provide an attachment point for the transparent tubular locating member 16 to attach to the front of the casing 12 without any modification being required to the camera 26.

In the present embodiment, the tubular locating member 16 comprises a cast acrylic tube coated with anti-reflective coatings on its inner and outer surfaces. A screw thread which corresponds with the threaded collar 14 is provided at one end of the locating member 16 in order to allow threaded connection of the locating member 16 to the threaded collar 14 and hence to the front of the casing 12. It will be appreciated that the threaded arrangement of collar 14 may be provided on the outer circumference thereof, and the threaded screw of the tubular locating member 16 may be provided on the inner circumference thereof; alternatively these could be swapped around if desired. A further resilient washer is provided between the collar 14 and the base of the tubular locating member 16 in order to maintain a substantially water-tight seal therebetween.

In the present embodiment of the invention, the field of view restrictor 18 comprises a cylindrical or similarly shaped outer profile having an optional conical inner profile which is sized to restrict the field of view (depicted by dotted lines F in FIG. 1) of the corrective lens 20 to that which includes only the area occupied by the convex mirror 22. This ultimately prevents the camera 26 from recording anything other than the image reflected from the convex mirror 22.

The convex mirror is attached to the cap 24 by adhesive or other attachment means. The outer circumference of the cap 24 is provided with a screw thread there around and the inner circumference of the end of the tubular locating member 16 is provided with a corresponding screw thread such that the cap 24, and hence the convex mirror 22 attached thereto, can be screwed into engagement with the tubular locating member 16 during assembly. In this regard, the components making up the adapter apparatus 10 of the present invention may be supplied to a user in a pre-assembled form or alternatively, may be provided in a kit form where the user must assembly the adapter (e.g. by screwing the various components together) prior to use.

When the user wishes to convert a standard camera 26 to one which is able to record a 360 degree image, he first secures the casing 12 around the camera 26. This provides a connection point (the locating collar 14) at the front of the camera 26 to which the rest of the adapter apparatus 10 can be securely attached, without requiring any modification to the camera 26.

The user then screws the lower end of the tubular locating member 16 onto the collar 14 on the front of the camera 26. The resulting apparatus is therefore now ready for use.

In use, the convex mirror 22 reflects light from its surroundings onto the corrective lens 20 thereby creating a circular image of the 360 degree view at the corrective lens 20. The resulting circular image reflected from the convex mirror 22 is then focussed by the corrective lens 20 into the existing lens and aperture arrangement 28 of the camera 26. Software can then be used to “unwrap” the resulting 360 degree still or moving recorded image.

As will be described subsequently, the refractive index and radius of curvature of the corrective lens 20 may be selected by the user prior to use depending upon the type of camera 26 and/or diameter of the convex mirror 22 used. Furthermore, the vertical position of the corrective lens 20 within the field of view restrictor 18 may be altered, either during manufacture, or prior to use by the user in order to account for different types of camera 26, different dimensions of locating member 16 and different dimensions of accompanying convex mirror 22. A screw-adjustable mechanism for adjusting the vertical position of the corrective lens 20 relative to the convex mirror 22, and hence the vertical position relative to the existing lens/aperture arrangement 28, may be installed within the field of view restrictor 18.

With reference to FIGS. 2 and 3, a second embodiment of the present invention will now be described. In order to minimise repetition, similar features of the apparatus described subsequently are numbered with a common two-digit reference numeral and are differentiated by a third digit placed before the two common digits. Such features are structured similarly, operate similarly, and/or have similar functions as previously described unless otherwise indicated.

In a second embodiment of the present invention the adapter apparatus 110 has a tubular member 116, and hence mirror 122, which is of a greater diameter than those of the first embodiment previously described. In order to accommodate for this variation in diameter, the width of the field of view restrictor 118 is therefore greater in order to increase the field of view thereof. This is depicted by dotted lines F in FIG. 2.

In this embodiment of the present invention, the corrective lens 120 may have a different refractive index and/or may be positioned higher or lower within the restrictor 118 in order to ensure that the light reflected from the larger diameter mirror 122 is optimally focussed on the existing lens/aperture arrangement 128 of the camera 126. A screw-adjustable mechanism for adjusting the vertical position of the corrective lens 120 relative to the convex mirror 122, and hence the vertical position relative to the existing lens/aperture arrangement 28, may be installed within the restrictor 118.

As best illustrated in FIG. 3, the front protruding element of the adapter apparatus 110 is provided with a seal 123 between its base attachment member 125 and the bottom edge of the tubular member 116 in order to prevent, or minimise, any ingress of water, dirt or other debris into the apparatus. At its uppermost end, the tubular member 116 is provided with an edge member 127 having an inwardly projecting shoulder which allows a corresponding outwardly projecting lip of the mirror 122 to rest thereon. A top cap 129 is engaged with the edge member 127 to secure the mirror 122 in place. Resilient seals 131, 133 are provided to secure the mirror in position and to also prevent ingress of water, dirt and other debris. The present invention therefore provides an adapter which can be easily attached to the front of an existing camera with no modifications being required to the existing camera itself. This creates a form of universal connection/standardisation which allows the apparatus to be used on a number of different camera units without requiring a number of different lens attachments etc. In this regard, padding or other support may be provided in order to retain the camera 26 securely within the casing 12 regardless of its dimensions. The ease of installation and removal of the present invention from an existing camera means that no, or minimal, skill is required in order to convert an existing camera to a camera having 360 degree capability and back again to a camera without this capability. Furthermore, the careful (and adjustable) positioning of the restrictor 18, 118 and corrective lens 20, 120 relative to the mirror 22, 122, in each embodiment means that the maximum number of pixels of the existing camera's sensor are exposed to the image reflected from the convex mirror 22, 122. This helps to ensure that a high quality image is obtained by the camera since the 360 degree image is effectively compressed into a small circular image on the camera's optical sensor.

Another advantage of the present invention is that the corrective lenses 20, 120 allow a smaller diameter convex mirror 22, 122 to be utilised and also allow the focal length of the image reflected from these mirrors to be reduced. Both of these advantages allow the overall dimensions of the adapter to be reduced.

A further advantage of the present invention is that the seal provided in the casing 12, the join between the tubular member 16 and collar 14, and the join provided between the mirror 22 and the tubular member 16 results in a substantially water-tight casing which can be safely used during water sports etc.

It is contemplated by the inventors that various substitutions, alterations, and modifications may be made to the invention without departing from the spirit and scope of the invention. Examples of these include the following:

Rather than the threaded collar 14, the adapter 10, 110 could be attached to the front of the camera 26, 126 by any appropriate means, such as strapping etc.

The adapter apparatus of the present invention may be an integrated unit designed to be retro-fitted to an existing camera or alternatively may be provided as an integrated unit supplied with a camera.

In addition to the anti-reflective coating on the tubular locating member 16, additional coatings may be provided to suit different environments in which the camera may be used. For example, a red filter coating may be provided for use in an underwater environment, or a polarised filter coating may be provided for use in environments where enhanced colour and sharpness is desired. This can be provided as an additional coating provided on the acyclic of the tubular locating member or as a selection of interchangeable tubular locating members which can be swapped for the clear member as required. Furthermore, a hydrophobic coating may be provided if desired.

Although not shown in the attached drawings, the 360 degree mirror may be provided with a centralised blanking pin projecting downwardly therefrom in order to frame the image received at the imaging device and prevent internal “ghost” reflections which may otherwise be detected by the imaging device.

The front projecting attachment of the apparatus may be integrally formed with the casing in order to provide a sealed mono structure (with a two part casing to allow insertion and removal of the camera unit).

1. A camera adapter and protective casing apparatus, the apparatus comprising:
a mirror arrangement adapted to reflect an image of a view surrounding at least a portion of the apparatus toward an existing lens of a camera;
a protective camera casing member;
a locating member attachment means provided on the protective camera casing member;
a locating member adapted to retain the mirror arrangement at a desired distance from said existing lens of the camera;
wherein casing attachment means are provided on the locating member for engagement with the locating member attachment means of the protective camera casing member such that the mirror may be secured relative to the existing lens of the camera to thereby focus said image reflected from the mirror arrangement into said existing lens of the camera in order to obtain a focused image of said view surrounding the apparatus characterized in that a seal is provided between the casing attachment means and the locating member attachment means in order to minimize, ingress of water and debris between the protective camera casing and the locating member; and wherein the protective camera casing encapsulates and protects the camera such that a seal against ingress of water and debris to the camera is provided.

2. Apparatus according to claim 1, wherein the locating member attachment means of the casing member comprises a collar arrangement having a threaded screw there around and the casing attachment means of the locating member comprises a corresponding threaded screw which allows the locating member to be selectively screwed into and out of engagement with the casing member.

3. Apparatus according to claim 1, wherein a support means is provided within the casing member for securing a portable imaging device relative to the casing member.

4. Apparatus according to claim 1, wherein the mirror arrangement comprises a 360 degree mirror adapted to reflect an image of a 360 degree view surrounding the apparatus toward an existing lens of an imaging device.

5. Apparatus according to claim 4, wherein the 360 degree mirror comprises a convex mirror.

6. Apparatus according to claim 4, further comprising a blanking member located toward the center of the 360 degree mirror in order to mitigate reflections there at and to frame said image reflected from said mirror into said existing lens of an imaging device.

7. Apparatus according to claim 6, wherein said blanking member comprises an elongated pin projecting downwardly from the center of said 360 degree mirror.

8. Apparatus according to claim 1, wherein the locating member comprises a substantially transparent tubular member.

9. Apparatus according to claim 8, wherein the transparent tubular member is adapted to locate an imaging device toward one end of the transparent tubular member and the mirror arrangement toward the other end of the transparent tubular member.

10. Apparatus according to claim 8, wherein the inner surface of the transparent tubular member comprises an anti-reflective coating.

11. Apparatus according to claim 8, wherein the outer surface of the transparent tubular member comprises an anti-reflective coating.

12. Apparatus according to claim 1, wherein the transparent tubular locating member comprises a colored and/or polarized filter.

13. Apparatus according to claim 8, wherein the substantially transparent tubular member and mirror arrangement are provided with mutual engagement means such that they can be selectively detached and attached to one another.

14. Apparatus according to claim 13, wherein the mutual engagement means comprises a screw thread provided between an end of the transparent tubular member and a circumference of a cap on which the mirror arrangement is mounted.

15. Apparatus according to claim 13, wherein the mutual engagement means further comprises an at least partially water-tight seal.

16. Apparatus according to claim 1, further comprising a field of view restrictor adapted to restrict the field of view of the existing lens of an imaging device substantially to that containing the mirror arrangement.

17. Apparatus according to claim 16, wherein the field of view restrictor comprises an at least partially conical inner profile.

18. Apparatus according to claim 17, wherein an integrated corrective lens arrangement is further provided in order to facilitate focusing of said image reflected from the mirror arrangement into said existing lens of an imaging device.

19. Apparatus according to claim 18, wherein the corrective lens is removably mounted within the field of view restrictor such that the corrective lens may be replaced with an alternative corrective lens.

20. Apparatus according to claim 18, wherein an actuating mechanism is provided in order to allow the position of the corrective lens relative to the mirror arrangement and existing lens of an imaging device to be adjusted.

21. Apparatus according to claim 20, wherein the actuating mechanism comprises a rotatable screw thread mounted adjustment device.

22. Apparatus according to claim 1, wherein the locating member is provided with an attachment arrangement to facilitate attachment of the apparatus to an imaging device.

23. Apparatus according to claim 22, wherein the attachment arrangement comprises a screw thread arrangement adapted to mate with a corresponding screw thread arrangement provided on an imaging device.

24. Apparatus according to claim 1 wherein the apparatus and casing comprises a single integrated mono-structure.

25. A camera comprising adapter apparatus according to claim 1.

26. A kit of parts comprising components according to claim 1.
